(19) United States
(12) Patent Application Publication
(10) Pub. No.: US 2010/0138052 A1
(43) Pub. Date: Jun. 3, 2010

(54) Device for Determining and/or Monitoring the Mass Flow Rate of a Gaseous Medium

(75) Inventor: Oliver Popp, Fislisbach (CH)

Correspondence Address: BACON & THOMAS, PLLC, 625 SLATERS LANE, FOURTH FLOOR, ALEXANDRIA, VA, 22314-1176, US

(73) Assignee: Endress + hasuer Flowtec AG, Reinach (CH)

(21) Appl. No.: 12/085,828

(22) PCT Filed: Nov. 30, 2006
(86) PCT No.: PCT/EP2006/069165

§ 371 Date: Nov. 30, 2009

(30) Foreign Application Priority Data
Dec. 1, 2005 (DE) 102005057688.5

(51) Int. Cl. G05D 7/06

(52) U.S. Cl. 700/282

(57) ABSTRACT

The invention relates to an apparatus for determining and/or monitoring mass flow of a gaseous medium through a pipeline (2) or through a measuring tube. The apparatus includes two temperature sensors (11, 12) and a control/evaluation unit (10). The two temperature sensors (11, 12) are arranged in a housing (5) facing the medium (3) and are in thermal contact with the medium flowing through the pipeline (2) or through the measuring tube. A first temperature sensor (11) is embodied to be heatable. A second temperature sensor (12) provides information concerning current temperature of the medium (3). The control/evaluation unit (10), on the basis of a temperature difference (ΔT) between the two temperature sensors (11, 12) and/or on the basis of heating power (Q) supplied to the first temperature sensor (11), ascertains mass flow of the medium (3). The control/evaluation unit (10), based on at least one additional process variable (p, T, v) of the flowing medium (3), ascertains a corrected value for the mass flow ascertained based on the temperature difference (ΔT) or the supplied heating power and makes available a corrected value (Qinc) for the mass flow through the pipeline (2) or through the measuring tube.

The invention relates to a thermal, or calorimetric, apparatus for determining and/or monitoring flow of a compressible medium flowing through a pipeline or through a measuring tube. The apparatus includes two temperature sensors and a control/evaluation unit, wherein a first temperature sensor is embodied to be heatable, wherein a second temperature sensor provides information concerning the current temperature of the medium, wherein the control/evaluation unit, on the basis of a temperature difference between the two temperature sensors and/or on the basis of heating power supplied to the first temperature sensor, ascertains mass flow of the medium, wherein the two temperature sensors are arranged in a region of a housing facing the medium and are in thermal contact with the medium flowing through the pipeline or through the measuring tube. The compressible medium is a gaseous or vaporous medium.

Conventional thermal flow-measuring devices use, most often, two temperature sensors, which are embodied to be, as much as possible, equal. For industrial application, the two temperature sensors are usually installed in a measuring tube, where the flow of the measured medium is measured. As already indicated above, one of the two temperature sensors is a so-called passive temperature sensor, which registers the current temperature of the measured medium. The other temperature sensor is a so-called active temperature sensor, which is heated by means of a heating unit. Provided as heating unit is either an extra resistance heating element, or the temperature sensor itself serves as a resistance element, e.g. an RTD (Resistance Temperature Device) sensor, which is heated by conversion of electrical power, e.g. by an appropriate variation of the electrical-current used for measuring.

Usually, in a thermal flow-measuring device, the heatable temperature sensor is so heated, that a fixed temperature difference is established between the two temperature sensors. Alternatively, it is also known to supply a constant heating power via a control unit, wherein the control may be open-loop, or closed-loop, control.

If there is no flow in the measuring tube, then a constant amount of heat is required for maintaining the predetermined temperature difference. If, in contrast, the medium to be measured is moving, the cooling of the heated temperature sensor depends essentially on the mass flow of the colder medium flowing past. Via the flowing medium, heat of the heated temperature sensor is transported away. In order, thus, in the case of a flowing medium, to maintain the fixed temperature difference between the two temperature sensors, a higher heating power is required for the heated temperature sensor. If a heating power constant over time is supplied, the temperature difference between the two temperature sensors lessens as a result of the flow of the medium. The change is then a measure for the mass flow through the pipeline or through the measuring tube.

There is, thus, a functional relationship between the heating energy needed for heating the temperature sensor and the mass flow through a pipeline or through a measuring tube. In general, it can be said, that the heat transfer coefficient depends on the mass flow of the medium through the measuring tube or through the pipeline. Thermal flow-measuring devices operating on the above described principle are available from and sold by the assignee under the designation ‘t-mass’.

It has now been found, that the heat transfer coefficient is only, to a first approximation, a measure for the mass flow of a medium in a pipeline or in a measuring tube. For highly accurate measurements, it is necessary to take further process variables into consideration. In the case of a compressible medium, these are pressure, flow velocity and temperature.

An object of the invention is to provide a thermal, flow-measuring device for highly accurate measuring of mass-flow of compressible media.

The object is achieved by the features, that the control/evaluation unit, on the basis of at least one additional process variable of the flowing medium, ascertains a corrected value for the mass flow ascertained on the basis of temperature difference, or supplied heating power, and makes available the corrected value for the mass flow through the pipeline or through the measuring tube. According to the invention, thus, the fact is taken into consideration, that, for equal mass flow, pressure, flow velocity and temperature have an influence on mass flow. The heat transfer coefficient is especially dependent on pressure and flow velocity, however also on the temperature of the medium flowing in the pipeline or in the measuring tube. In a further development of the apparatus of the invention, it can, thus, be said, that the ascertained corrected value for mass flow depends on flow velocity of the gaseous or vaporous, compressible medium.

Viewed as especially advantageous in connection with the present invention is when the corrected value for mass flow is ascertained as a function of the Mach number of the flowing, gaseous medium, wherein the Mach number (M) is equal to the quotient of the flow velocity (v) and the velocity of sound c in the gaseous medium. For equal flow velocity, the Mach number can significantly vary as a function of the velocity of sound in the medium flowing through the pipeline or through the measuring tube. Thus, for example, hydrogen gas has a very high velocity of sound, which means that the Mach number of hydrogen gas is relatively small, while the velocity of sound in carbon dioxide is relatively small, which results in a relatively large Mach number.

In an advantageous embodiment of the apparatus of the invention, it is provided, that the corrected value for the power to be supplied to the first heatable temperature sensor is calculated according to the following formula:

$${Q}_{inc} = Q \cdot [ const . \cdot ( 1 + \frac{γ - 1}{2} \cdot {M}^{2} ) - 1 ] ,$$

wherein Q_{inc}, is the heating power supplied to the heatable temperature sensor in the range of small flow velocities of the medium, when, thus, v<<c. In this range, the flowing medium behaves in the manner of an incompressible medium. Q is the heating power supplied to the heatable temperature sensor at a given velocity. γ is the isentropic exponent of the gas, and c is the velocity of sound. Both variables depend, generally, on which gas it is, as well as on the thermodynamic state of the gas. The ratio of Q_{inc}, to Q corresponds, thus, to the heating power of the thermal flow-measuring device of the invention normalized to the supplied heating power in the case of incompressible media.

Due to the quadratic dependence of the normalized heating power on the Mach number, a consideration of the additional process variables or an appropriate correction of the mass flow of a compressible medium becomes more important, the larger the Mach number is. This means, on the one hand, that, at equal velocity of sound, the correction becomes more important, the higher the flow velocity of the medium is in the pipeline or measuring tube. On the other hand, it means, that a correction due to a pressure change at equal flow velocity becomes more important, the larger the velocity of sound is in the gaseous or vaporous medium. Thus, according to the invention, it can also be provided, that the correction capability is turned on or off by the operator, depending on the circumstances. Alternatively, the control/evaluation unit can itself decide on the basis of appropriate inputs, whether a correction should occur or not. For example, the correction variable should at least be as large as the measurement error.

In a preferred embodiment of the apparatus of the invention, the value of the constant const. is experimentally ascertained.

The invention will now be explained in greater detail on the basis of the appended drawing, the figures of which show as follows:

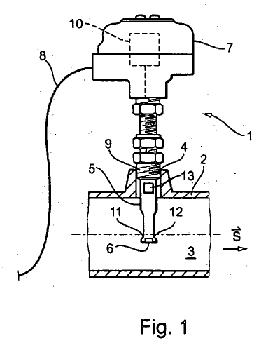

FIG. 1 schematic drawing of the thermal flow-measuring device of the invention;

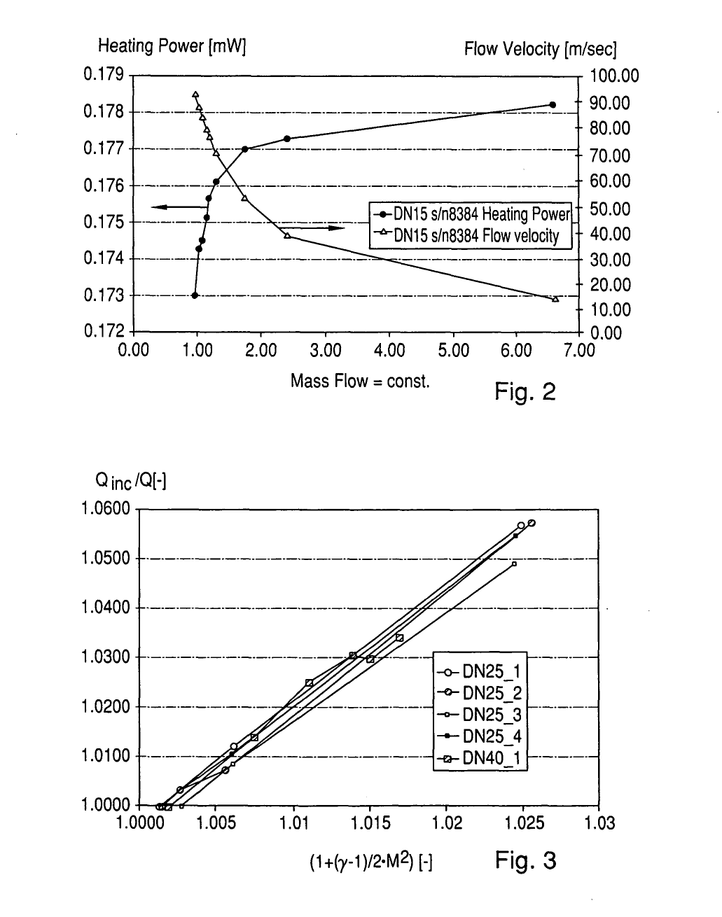

FIG. 2 diagram of heating power and flow velocity as functions of pressure;

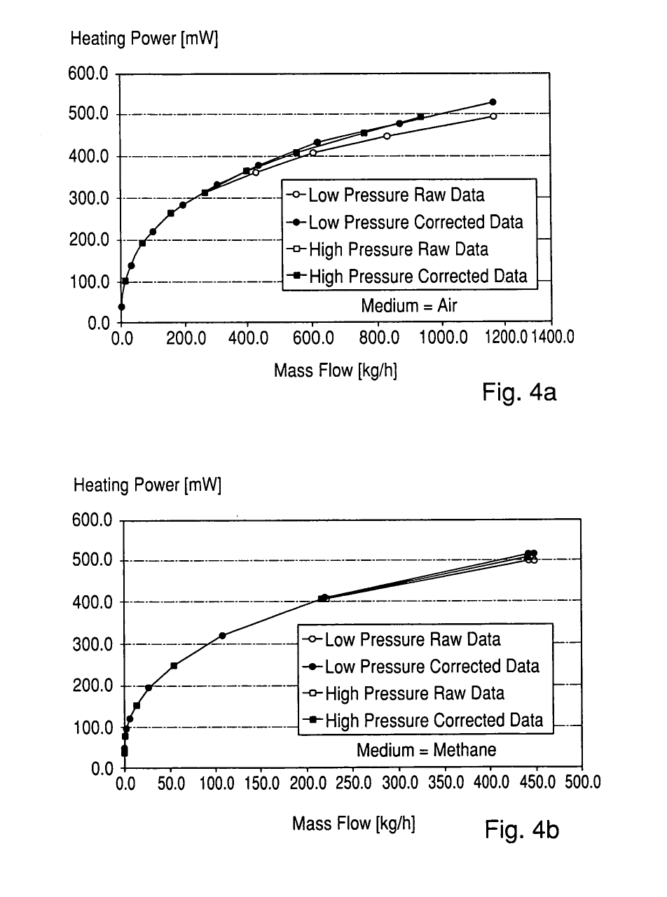

FIG. 3 diagram indicating dependence of heating power on Mach number;

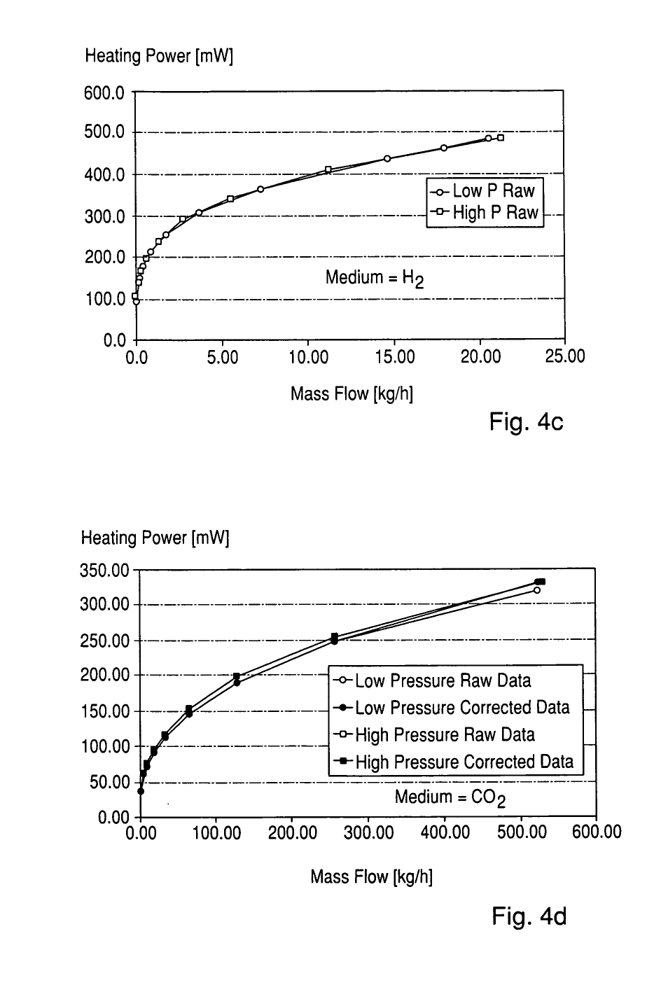

FIG. 4a diagram of heating power versus mass flow of air for corrected and non-corrected data in the case of two different pressures;

FIG. 4b diagram of heating power versus mass flow of methane for corrected and non-corrected data in the case of two different pressures;

FIG. 4c diagram of heating power versus mass flow of hydrogen for corrected and non-corrected data in the case of two different pressures; and

FIG. 4d diagram of heating power versus mass flow of carbon dioxide for corrected and non-corrected data in the case of two different pressures.

FIG. 1 shows a schematic drawing of the thermal flow-measuring device 1 of the invention, including thermal flow-sensor 6 and measurement transmitter 7. The flow-measuring device 1 is secured via a screw thread 9 in a nozzle 4 of the pipeline 2. Located in the pipeline 2 is the flowing medium 3. Alternatively, the flow-measuring device 1 can be embodied with an integrated measuring tube as an inline-measuring device.

The temperature measuring device, which is an essential part of the sensor 6, is located in the region of the housing 5 facing the medium 3. The operating of the temperature sensors 11, 12 and/or the evaluation of the measurement signals delivered by the temperature sensors 11, 12 are/is accomplished via the control/evaluation unit 10, which, in the illustrated case, is located in the measurement transmitter 7. Communication with a remote control-location is accomplished via the connection 8.

As already mentioned above, in the case of at least one of the two temperature sensors 11, 12, such is an electrically heatable resistance element, a so-called RTD-sensor. Of course, in connection with the solution of the invention, also a usual temperature sensor, e.g. a Pt100 or Pt1000 or a thermocouple can be used, with which a thermally coupled heating unit 13 is associated. The heating unit 13 is arranged in FIG. 1 in the housing 5 and thermally coupled with the heatable temperature sensor 11, 12, while, however, being largely decoupled from the medium. The coupling and decoupling are accomplished, respectively, preferably, via filling of the appropriate intermediate spaces with, respectively, thermally well conducting, and thermally poorly conducting, material. Preferably, a potting compound is used in this connection.

Mass flow can be measured continuously with flow-measuring device 1; alternatively, flow-measuring device 1 can be applied as a switch, which displays a changed switch state, when at least one predetermined limit value is subceeded (fallen beneath) or exceeded.

Advantageously, it is further provided, in an alternative embodiment, that both temperature sensors 11, 12 are heatable, with the desired functioning of the first temperature sensor 11 or the second temperature sensor 12 being determined by the control/evaluation unit 10. For example, the control/evaluation unit 10 can activate the two temperature sensors 11, 12 alternatingly as active or passive temperature sensors 11, 12 and the measured value of flow can be ascertained via an averaging of the measured values delivered by the two temperature sensors 11, 12.

In the case of the diagram shown in FIG. 2, heating power Q and flow velocity v are plotted versus various pressures p reigning in the pipeline 2 or in the measuring tube. Temperature T and mass flow are, in each case, held constant. In the range 1 bar up to 2 bar, heating power Q rises steeply as a function of the pressure reigning in the pipeline 2 and moves then into a region above 2 bar characterized by a curve Q(p) of moderated slope.

The curve for flow velocity v as a function of the pressure reigning in the pipeline 2 or in the measuring tube has an analogous behavior as regards slope, with the sign, however, being opposite. In the region of smaller pressures p, the curve v(p) falls relatively rapidly and then displays in the area above 2 bar a markedly flatter, negative slope. In order to measure mass flow through the pipeline 2, or through the measuring tube, highly accurately, thus, the influence of the different process variables v, p, T on the mass flow must be taken into consideration.

In a preferred embodiment of the apparatus of the invention, the normalized variable Q_{inc}/Q depends uniquely on Mach number M. Especially, the dependence can be described by the following formula:

$${Q}_{inc} = Q \cdot [ const . \cdot ( 1 + \frac{γ - 1}{2} \cdot {M}^{2} ) - 1 ] ,$$

Here, Q_{inc}, is the heating power Q supplied to the heatable temperature sensor 11 in the range of smaller flow velocities v of the medium 3, where, thus, v<<c. In this range, the flowing medium 3 behaves as an incompressible medium. Q is the heating power supplied to the heatable temperature sensor 11 at a given velocity. γ is the isentropic exponent of the gas, and c is the velocity of sound. Both variables depend, generally, on which gas it is and on the thermodynamic state of the gas. The ratio of Q_{inc} to Q corresponds, thus, to the heating power Q_{inc} of the thermal flow-measuring device 1 of the invention normalized on the heating power Q supplied in the case of incompressible media.

FIG. 3 shows a diagram illustrating the functional relationship between normalized heating power Q_{inc}/Q and a function dependent on Mach number M. Especially, there is a quadratic dependence of Q_{inc}/Q on Mach number M. Explicitly, the dependence can be represented mathematically by the function already cited in connection with FIG. 2.

In the figures, FIG. 4a, FIG. 4b, FIG. 4c and FIG. 4d, are plotted the uncorrected measured values of a thermal flow-measuring device 1 and the corresponding corrected measured values, as corrected according to the invention, versus mass flow. On the basis of the figures, it is evident, that the corrected measured values correlate with mass flow almost independently of pressure: They are distinguished by a clear and unique dependence on mass flow.

As evident by a comparison of the figures, FIG. 4a, FIG. 4b, FIG. 4c, FIG. 4d, with one another, this statement is also true for the most varied of media. FIG. 4a shows the functional dependence of the heating power Q, essentially only still dominated by mass flow, when air is flowing through the pipeline 2 or the measuring tube. The corrected values are almost independent of pressure. FIG. 4b, FIG. 4c and FIG. 4d show the corresponding diagrams for methane, hydrogen and carbon dioxide. In such case, methane has, with 0.3, the greatest Mach number M, while hydrogen has the lowest Mach number M, at 0.05.

### LIST OF REFERENCE CHARACTERS

1 thermal flow-measuring device
2 pipeline/measuring tube
3 measured medium
4 nozzle
5 housing
6 sensor
7 transmitter
8 connecting line
9 thread
10 control/evaluation unit
11 first temperature sensor
12 second temperature sensor
13 heating unit

1-5. (canceled)

6. An apparatus for determining and/or monitoring the mass flow of a gaseous medium through a pipeline or through a measuring tube, comprising:
two temperature sensors; and
a control/evaluation unit, wherein:
said two temperature sensors are arranged in a housing facing the medium and are in thermal contact with the medium flowing through the pipeline or through the measuring tube,
a first temperature sensor of said two temperature sensors is embodied to be heatable;
a second temperature sensor provides information concerning current temperature of the medium;
said control/evaluation unit ascertains mass flow of the medium on the basis of a temperature difference between said two temperature sensors and/or on the basis of heating power supplied to said first temperature sensor; and
said control/evaluation unit, based on at least one additional process variable of the flowing medium, ascertains a corrected value for the mass flow ascertained based on the temperature difference or the supplied heating power and makes available a corrected value for the mass flow through the pipeline or through the measuring tube.

7. The apparatus as claimed in claim 6, wherein:
said corrected value depends on flow velocity of the gaseous medium.

8. The apparatus as claimed in claim 6, wherein:
said corrected value depends on the Mach number of the flowing gaseous medium, the Mach number equals the quotient of flow velocity and velocity of sound in the gaseous medium.

9. The apparatus as claimed in claim 8, wherein:
said corrected value for power to be supplied to said first heatable temperature sensor is calculated according to a formula as follows:
$${Q}_{inc} = Q \cdot [ const . \cdot ( 1 + \frac{γ - 1}{2} \cdot {M}^{2} ) - 1 ] ,$$
wherein Q_{inc} is the energy supplied to said heatable temperature sensor at a small flow velocity of the medium, when, thus, v<<c, and wherein γ is the isentropic exponent of the gas and c the velocity of sound in the gas.

10. The apparatus as claimed in claim 9, wherein:
the const. is an experimentally ascertained value.
